(19) United States
(12) Patent Application Publication
(10) Pub. No.: US 2013/0222768 A1
(43) Pub. Date: Aug. 29, 2013

(54) SHAPED REAR PROJECTION SCREEN WITH SHAPED FRESNEL LENS SHEET

(71) Applicants: Rolf W. Biernath, Wyoming, MN (US); Brian T. Weber, Saint Paul, MN (US)

(72) Inventors: Rolf W. Biernath, Wyoming, MN (US); Brian T. Weber, Saint Paul, MN (US)

(73) Assignee: 3M Innovative Properties Company

(21) Appl. No.: 13/407,053

(22) Filed: Feb. 28, 2012

(51) Int. Cl. G03B 21/14; G03B 21/62

(52) U.S. Cl. 353/20; 353/69

(57) ABSTRACT

A system for projecting content onto a shaped screen. The system includes a projector configured for projecting content having a particular shape and a rear projection screen with an optically active light redirecting film, such as Fresnel lenses, for receiving and displaying the projected content. The rear projection screen and the optically active light redirecting film each have a shape substantially conforming to the particular shape of the content. The optically active light redirecting film, such as a Fresnel lens sheet, provides for brightness uniformity and a wide view angle. The rear projection screen can include a turning film for displaying content received from the projector at an angle.

### BACKGROUND

Rear projection films are increasingly used in digital point of purchase signage. One type of signage involves use of a shaped rear projection film with the shape of the film corresponding with a shape of content to be displayed on it, as described in U.S. Pat. No. 7,923,675. One of the challenges with using these rear projection films in point of purchase applications relates to the long throw distance of most projectors, typically measuring two to three times the long axis of the display. The expansion angle of the image emanating from the projector increases dramatically when the throw distance is shortened. When the entrance angle of the image projected onto the rear projection screen is increased, the light capture efficiency of the screen decreases rapidly. This phenomenon results in significant uniformity and view angle loss, and it can lead to an observable hot spot in the center of the image, which moves around as the viewer changes position, leading to poor useful view angle. Accordingly, a need exists for an improved rear projection screen, particularly for digital signage.

### SUMMARY

A system for projecting content onto a shaped screen, consistent with the present invention, includes a projector configured for projecting content having a particular shape and a rear projection screen with an optically active light redirecting film for receiving and displaying the projected content. The rear projection screen and the optically active light redirecting film each have a shape substantially conforming to the particular shape of the content.

### BRIEF DESCRIPTION OF THE DRAWINGS

The accompanying drawings are incorporated in and constitute a part of this specification and, together with the description, explain the advantages and principles of the invention. In the drawings,

FIG. 1 is a perspective view of system having a shaped rear projection screen with a shaped optically active light redirecting film;

FIG. 2 is a perspective view of system having a shaped rear projection screen with a shaped optically active light redirecting film and having content projected at an angle to the film;

FIG. 3A is a side sectional view of a shaped rear projection screen with a shaped optically active light redirecting film;

FIG. 3B is a side sectional view of an alternate embodiment of the screen of FIG. 3A;

FIG. 4A is a side sectional view of a shaped rear projection screen with a shaped optically active light redirecting film and a turning film;

FIG. 4B is a side sectional view of an alternate embodiment of the screen of FIG. 4A;

FIG. 5 is a perspective view of a shaped rear projection screen within a projection window of a static graphic; and

FIG. 6 is an exploded perspective view of two substrates each having a shaped projection window with a rear projection film contained between the substrates.

### DETAILED DESCRIPTION

Embodiments of the present invention include the use of a shaped optically active light redirecting film with the shaped rear projection film, where the shape corresponds with a shape of content to be displayed. The inclusion of an optically active light redirecting film results in both improved image brightness uniformity and a wider useful view angle of the projected image for short throw projectors. Additionally, the smooth side of the optically active light redirecting film can be treated with hard coats, easy clean coatings, antireflective coatings, anti-smudge coatings, and the like. Alternatively, the structured side of the optically active light redirecting film can be treated with such coatings provided the desired optical properties of the film are maintained.

Examples of optically active light redirecting films include, but are not limited to, the following: Fresnel lenses (circular, cylindrical, elliptical, or linear); microstructured optical films; and portions and combinations thereof. When Fresnel lenses are used, a circular Fresnel is preferred for direct projection from behind. An elliptical or linear Fresnel is preferred for cases where the projector is located away from the perpendicular axis of the projection surface, such as below, above, or to the side. A turning film may be used for cases where the projector is substantially off of the perpendicular axis with respect to the rear projection screen. For all these cases, one or both faces of the optically active light redirecting film may be structured. Additionally, the structured side of the film may be facing toward or away from the projector, depending on which provides the optimal optical performance and durability in the usage scenario, for example. The optically active film may also be of sufficient thickness to be considered a sheet or plate.

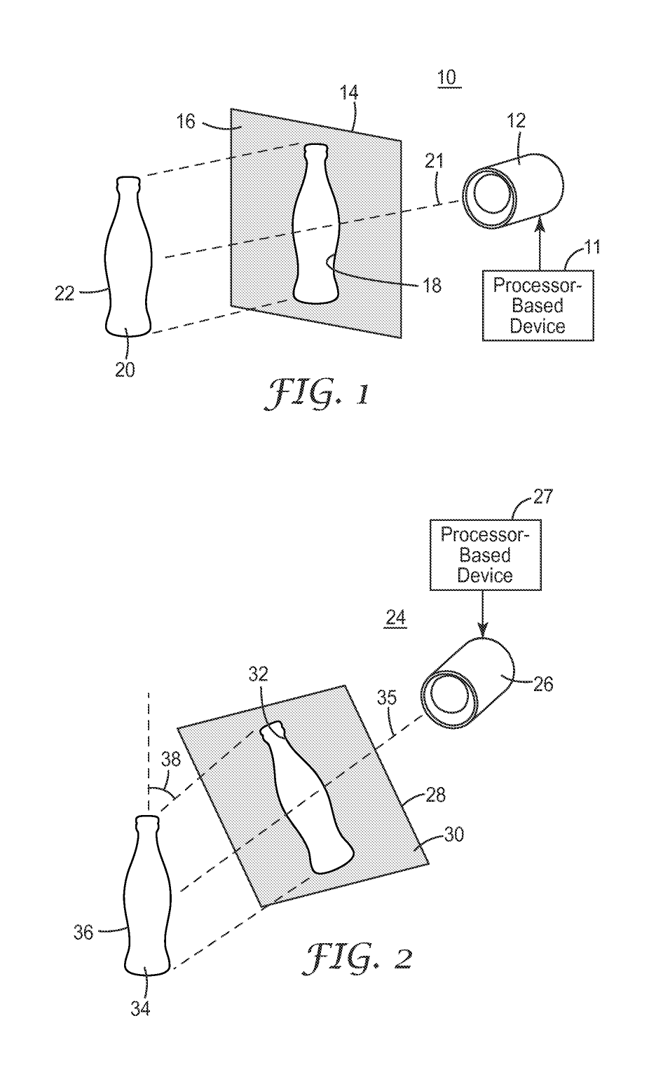

FIG. 1 is a perspective view of system 10 having a shaped rear projection screen with a shaped optically active light redirecting film. System 10 includes a projector 12 for projecting changeable electronic content, a processor-based device 11 for electronically providing content to projector 12, a virtual mask 14 having a projection area 18, and a shaped rear projection screen 20. Processor-based device 11 can implement virtual mask 14 in software to effectively block content in region 16 such that the displayed content, as represented by line 21, is projected within projection area 18 and substantially conforms to the shape of projection screen 20 as defined by its outer edge 22. As explained below, rear projection screen 20 includes a shaped optically active light redirecting film having a shape corresponding with outer edge 22.

FIG. 2 is a perspective view of system 24 having a shaped rear projection screen with a shaped optically active light redirecting film and having content projected at an angle to the film. System 24 includes a projector 26 for projecting changeable electronic content, a processor-based device 27 for electronically providing content to projector 26, a virtual mask 28 having a projection area 32, and a shaped rear projection screen 34. Processor-based device 27 can implement virtual mask 28 in software to effectively block content in region 30 such that the displayed content, as represented by line 35, is projected within projection area 32 and substantially conforms to the shape of projection screen 34 as defined by its outer edge 36. As explained below, rear projection screen 34 includes a shaped optically active light redirecting film having a shape corresponding with outer edge 36. In system 24, the content is projected from projector 26 to projection screen 34 at an angle 38. Projecting the content at an angle allows, for example, for the projector to be located closer to the projection screen and possibly out of view.

Rear projection screens, including shaped screens, are described in U.S. Pat. Nos. 7,923,675 and 6,870,670, both of which are incorporated herein by reference as if fully set forth.

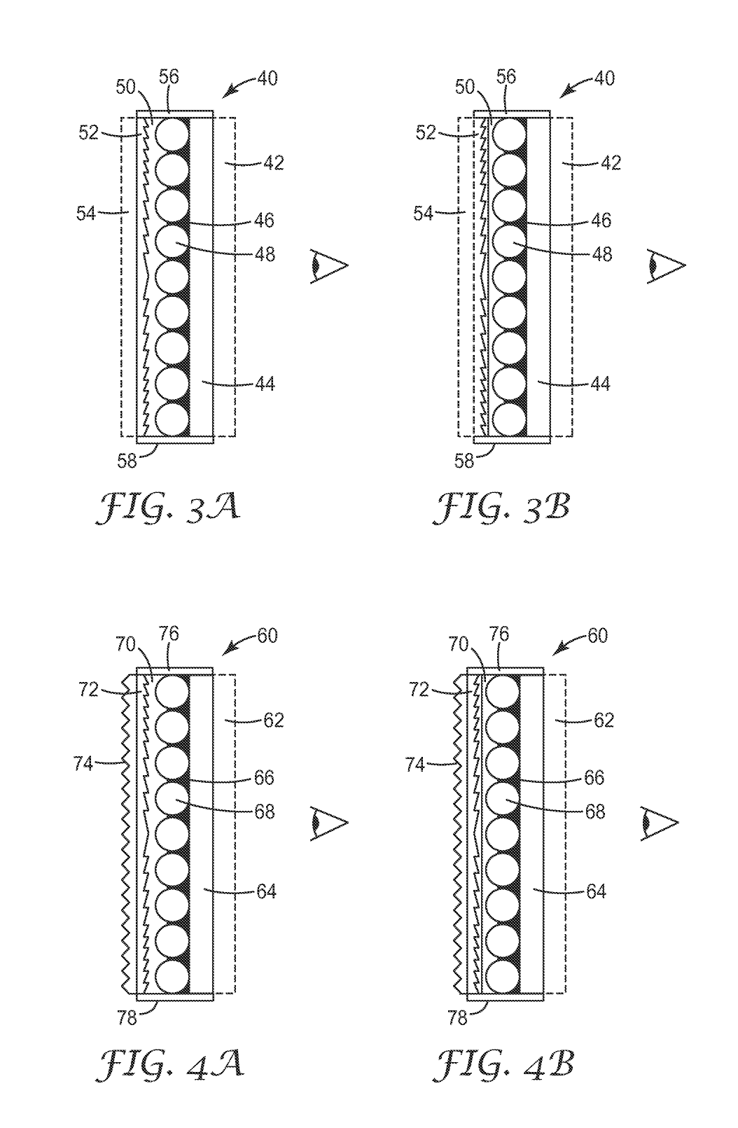

FIG. 3A is a side sectional view of a shaped rear projection screen 40 with a shaped optically active light redirecting film. Rear projection screen 40 includes refractive elements 48 such as glass beads in a light absorbing layer 46 such as a black matrix, a light transmitting substrate 44 such as flexible film, an optically active light redirecting film 52 facing refractive elements 48, and a space 50 between optically active light redirecting film 52 and refractive elements 48. Rear projection screen 40 can optionally include a support substrate 42 on the viewer side such as glass or other rigid material and can optionally include optical films 54 such as a polarizer (reflective or absorptive) on the non-viewer side adjacent optically active light redirecting film 52. Rear projection screen 40 can include edge seals 56 and 58 in order to seal the corresponding components with a thermal treatment or adhesive, for example. The combination of light transmitting substrate 44, light absorbing layer 46, and refractive elements 48 can be implemented with, for example, the product identified in the Example or other types of rear projection screens. Space 50 can include an air gap, an adhesive, or a low index layer. FIG. 3B illustrates that the rear projection screen 40 can alternatively have optically active light redirecting film 52 facing away from refractive elements 48. Rear projection screen 40 from the viewer's perspective would be shaped to conform to content projected upon it as shown in the system of FIG. 1.

FIG. 4A is a side sectional view of a shaped rear projection screen 60 with a shaped optically active light redirecting film and a turning film. Rear projection screen 60 includes refractive elements 68 such as glass beads in a light absorbing layer 66 such as a black matrix, a light transmitting substrate 64 such as flexible film, an optically active light redirecting film 72 facing refractive elements 68, and a space 70 between optically active light redirecting film 72 and refractive elements 68. Rear projection screen 60 can optionally include a support substrate 62 on the viewer side such as glass or other rigid material. Rear projection screen 60 can include edge seals 76 and 78 in order to seal the corresponding components with a thermal treatment or adhesive, for example. The combination of light transmitting substrate 64, light absorbing layer 66, and refractive elements 68 can be implemented with, for example, the product identified in the Example or other types of rear projection screens. Space 70 can include an air gap, an adhesive, or a low index layer. FIG. 4B illustrates that the rear projection screen 60 can alternatively have optically active light redirecting film 72 facing away from refractive elements 48. In this embodiment, rear projection screen 60 also includes a turning film 74 on the non-viewer side for situations where the content is projected at an angle to rear projection screen 60. Rear projection screen 60 from the viewer's perspective would be shaped to conform to content projected upon it as shown in the system of FIG. 2.

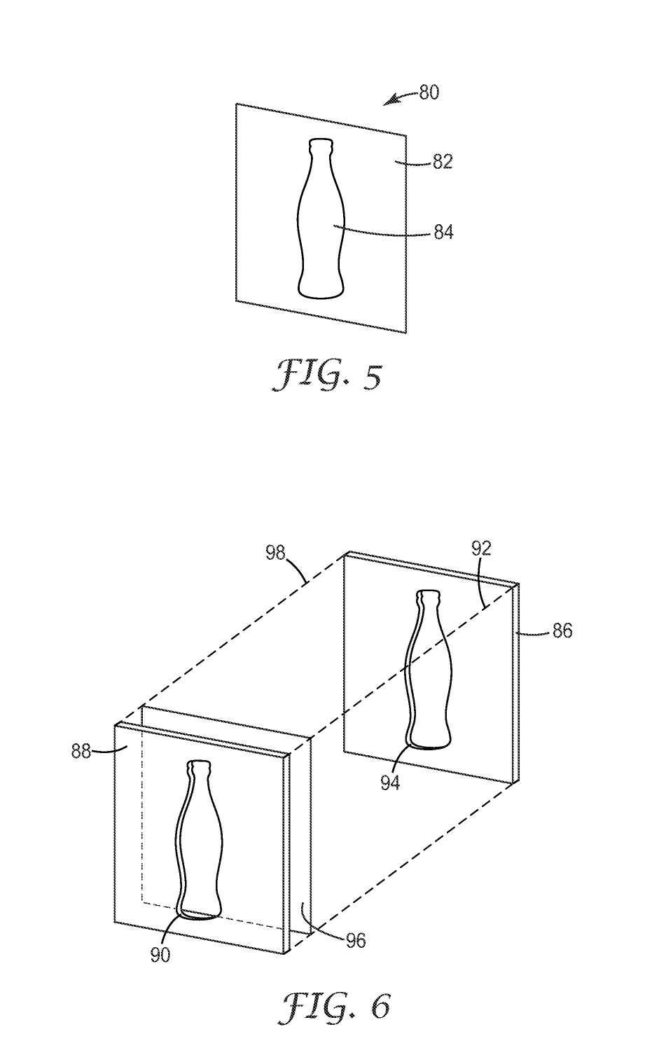

FIG. 5 is a perspective view of a shaped rear projection screen 84 within a projection window of a static graphic 80. Static graphic 80 includes a cut-out portion to accommodate and conform to the shape of rear projection screen 84 such as the rear projection screens described above. A region 82 would include static content such as an advertisement or product promotional information.

FIG. 6 is an exploded perspective view of two substrates 86 and 88 each having a shaped projection window with a rear projection screen 96 contained between the substrates. In particular, substrates 86 and 88 include, respectively, cut-out portions 94 and 90 each having a shape corresponding with a desired shape of the rear projection screen. Rather than having the rear projection screen itself shaped, the cut-out portions define the shape for the rear projection screen such as the rear projection screens described above. The combination of substrates 86 and 88 with rear projection screen 96 can be edge sealed together as represented by lines 92 and 98. Substrates 86 and 88 can be implemented with, for example, glass or other rigid material.

The rear projection screen constructions of FIGS. 5 and 6 can be used as the rear projection screens in the systems of FIGS. 1 and 2 to display projected content.

In the above description, a bottle shape is used as the shape of the rear projection screen for illustrative purposes only. The rear projection screens can be shaped to conform to any desired content to be projected upon them. Although a virtual mask having a projection area to create the particular shape of the content is described above, a physical mask can also be used to create the particular shape the content, or both a virtual and a physical mask can be used. In addition to the above description, the Example provides materials and components for implementing the shaped rear projection screens.

### Example

This Example is merely for illustrative purposes only and is not meant to be limiting on the scope of the appended claims. A shaped rear projection screen was produced such that the Fresnel lens element in the screen construction enabled a brighter light output from the shaped rear projection screen.

A 30 cm×50 cm sheet of Rear Projection Film (RPF) with OCA (optically clear removable adhesive) (the combination being commercially available as VIKUITI XRVS Rear Projection Display Screen, available from 3M Company, St. Paul, Minn.) was obtained.

The RPF with OCA were cut to a unique shape with a model DC4SX cutter (available from Summa, Inc., Seattle, Wash.). The RPF with adhesive were applied to a 0.5 cm thick glass panel. A 26.0 cm×18.4 cm×0.5 mm thick vinyl Fresnel lens sheet #MJ019AB (origination Taiwan, obtained from Xump.com, Product #10127) with a 2:1 magnification was cut to the same unique shape as the RPF with OCA using the model DC4SX cutter. The Fresnel sheet was too thick for the cutter to cut completely through, but sufficiently thin for a scoring-cut to be made. The shaped Fresnel sheet was peeled away from its surrounding sheet along the scoring lines. The shaped Fresnel sheet was placed with its structured side facing the rough side of the RPF according to the configuration shown in FIGS. 1 and 3A. Small pieces of gloss finish SCOTCH transparent tape (available from 3M Company, St. Paul, Minn.) were used to attach the Fresnel sheet to the RPF and OCA around the edge to form the shaped rear projection screen.

An MPro 160 LCOS pico projector (available from 3M Company, St. Paul, Minn.) with a minimum focal distance of 15.2 cm was fitted with and tested using various wide angle lenses models: Vivitar 0.21× Fisheye Lens (item # VIV-21-37W, available from Sakar International, Edison, N.J.), Digital Concepts 0.42× Professional Fisheye Lens with macro (item #2237W, available from Sakar International, Edison, N.J.), and Kenko 0.5× Wide-Angle Conversion Lens (item #SGW-05, available from Kenko Tokina Co. Tokyo, Japan). In this Example, the distance between the projector front edge and the glass panel with the shaped rear projection screen was 17.8 cm as measured from the original lens of the projector to the screen, using the configuration shown in FIG. 1.

Brightness was measured with a luminance meter, model LS-100 (available from Konica Minolta Holdings, Inc., Tokyo, Japan). Data was taken at the shaped rear projection screen center and corner, shown in the Tables below for multiple lenses. For the 0.5× lens the improvement using the Fresnel sheet was seen in the brightness of the corner, improving from ˜80 nits to 261 nits, which also resulted in a corner-to-center brightness ratio improvement of approximately 370%.

Brightness and Brightness Ratio (No Fresnel)

| | No | | | |
|---|---|---|---|---|
| | Lens | 0.21x | 0.42x | 0.5x |
| Center Brightness (cd/m\hat{ }2, no | 1160 | 335 | 293 | 689 |
| Fresnel) | | | | |
| Corner Brightness (cd/m\hat{ }2, no | 474 | 7 | 4.17 | 79.3 |
| Fresnel) | | | | |
| Brightness Ratio (Corner/Center) | 0.41 | 0.021 | 0.014 | 0.12 |

Brightness and Brightness Ratio (With Fresnel)

| | No | | | |
|---|---|---|---|---|
| | Lens | 0.21x | 0.42x | 0.5x |
| Center Brightness (cd/m\hat{ }2, with | 1024 | 301 | 254 | 612 |
| Fresnel) | | | | |
| Corner Brightness (cd/m\hat{ }2, with | 631 | 41.0 | 23.5 | 261 |
| Fresnel) | | | | |
| Brightness Ratio (Corner/Center) | 0.62 | 0.14 | 0.093 | 0.43 |

Percent Improvement in Brightness Ratio by using Fresnel

| | No | | | |
|---|---|---|---|---|
| | Lens | 0.21x | 0.42x | 0.5x |
| Brightness Ratio Improvement | 151% | 652% | 650% | 371% |
| using Fresnel | | | | |

1. A system for projecting content onto a shaped screen, comprising:
a projector configured for projecting content having a particular shape;
a rear projection screen for receiving and displaying the projected content; and
an optically active light redirecting film located adjacent a non-viewer side of the rear projection screen,
wherein the rear projection screen and the optically active light redirecting film each have a shape substantially conforming to the particular shape of the content.

2. The system of claim 1, wherein the optically active light redirecting film has a structured side facing toward a non-viewer side of the rear projection screen.

3. The system of claim 1, wherein the optically active light redirecting film has a structured side facing away from a non-viewer side of the rear projection screen.

4. The system of claim 1, further comprising an air gap between the rear projection screen and the optically active light redirecting film.

5. The system of claim 1, further comprising a low index layer between the rear projection screen and the optically active light redirecting film.

6. The system of claim 1, wherein the rear projection screen and the optically active light redirecting film are edge sealed together.

7. The system of claim 1, further comprising a polarizer located proximate the rear projection screen.

8. The system of claim 7, wherein the polarizer comprises a reflective polarizer.

9. The system of claim 7, wherein the polarizer comprises an absorptive polarizer.

10. The system of claim 1, wherein the rear projection screen and the optically active light redirecting film are contained within a static graphic having a cut-out portion conforming to the shape of the rear projection screen.

11. The system of claim 1, wherein the rear projection screen and the optically active light redirecting film are contained between two substrates, each of the substrates having a cut-out portion to define the shape of the rear projection screen and the optically active light redirecting film.

12. The system of claim 1, wherein the optically active light redirecting film comprises a Fresnel lens.

13. The system of claim 1, further comprising a mask, wherein the mask has a projection area determining the particular shape of the content.

14. A system for projecting content onto a shaped screen, comprising:
a projector configured for projecting content having a particular shape;
a rear projection screen for receiving and displaying the projected content;
an optically active light redirecting film located adjacent a non-viewer side of the rear projection screen; and
a turning film located adjacent a side of the optically active light redirecting film opposite the rear projection screen,
wherein the rear projection screen and the optically active light redirecting film each have a shape substantially conforming to the particular shape of the content,
wherein the projector projects the content to the rear projection screen at a non-perpendicular angle to the rear projection screen.

15. The system of claim 14, wherein the optically active light redirecting film has a structured side facing toward a non-viewer side of the rear projection screen.

16. The system of claim 14, wherein the optically active light redirecting film has a structured side facing away from a non-viewer side of the rear projection screen.

17. The system of claim 14, further comprising an air gap between the rear projection screen and the optically active light redirecting film.

18. The system of claim 14, further comprising a low index layer between the rear projection screen and the optically active light redirecting film.

19. The system of claim 14, wherein the rear projection screen and the optically active light redirecting film are edge sealed together.

20. The system of claim 14, wherein the optically active light redirecting film comprises a Fresnel lens.
